(19) United States
(12) Patent Application Publication
(10) Pub. No.: US 2019/0287130 A1
(43) Pub. Date: Sep. 19, 2019

(54) NETWORK-BASED PROVISIONING OF USER REWARDS

(71) Applicant: T-Mobile USA, Inc., Bellevue, WA (US)

(72) Inventors: Araceli Lesko, Bainbridge Island, WA (US); Aaron Drake, Sammamish, WA (US)

(21) Appl. No.: 15/920,318

(22) Filed: Mar. 13, 2018

(51) Int. Cl. G06Q 30/02; G06F 17/30

(52) U.S. Cl. CPC G06Q 30/0226; G06Q 30/0209; G06F 17/30943

(57) ABSTRACT

Systems and methods are described herein for provisioning rewards to users of telecommunications networks via various network-based processes. In some embodiments, the systems and methods determine a user has performed an activity or action associated with an external online event, such as a branded or sponsored event. In response to the activity or action, the systems and methods update or modify a database associated with the user and provided by a telecommunications network, such as a network that provides communication services to the user, with a credit associated with the external online event. The database may store or track credits or other currency or tokens associated with redeeming awards provided via the network by various sponsoring entities, companies, or brands.

### BACKGROUND

Often, multiple companies, via their brands, join forces and become partners, to their mutual benefit. For example, one company, having a large number of users or customers, may work with another company, which provides discounted or free services or products to the first company's large base of customers. In doing so, the first company provides a benefit (discounted products/services) to its customers, while the second company expands its reach to new customers (via the first company).

However, there are various problems associated with such an arrangement. For example, there are often delays between when a customer is apprised of a benefit (e.g., a reward provided during an online marketing event) and when the customer receives the reward. Once delayed, the customer is unlikely to attribute the reward to the brands sponsoring the reward (e.g., either the first company or the second company), obviating any benefits that should flow to either company when providing the reward to the customer. These and other drawbacks exist with respect to providing rewards to customers and other users.

### BRIEF DESCRIPTION OF THE DRAWINGS

Embodiments of the present technology will be described and explained through the use of the accompanying drawings.

FIG. 1 is a block diagram illustrating a suitable computing environment for provisioning rewards to users of a telecommunications network.

FIG. 2 is a block diagram illustrating various modules of an internal enterprise server.

FIG. 3 is a flow diagram illustrating a method for providing a reward to a user of a telecommunications network.

FIG. 4 is a flow diagram illustrating a method for determining the authenticity of a user reward recipient device.

FIG. 5 is a display diagram illustrating an example user interface for presenting information associated with a user's reward activity.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

### Overview

Systems and methods are described herein for provisioning rewards to users of telecommunications networks via various network-based processes. In some embodiments, the systems and methods determine a user has performed an activity or action associated with an external online event, such as a branded or sponsored event. In response to the activity or action, the systems and methods update or modify a database associated with the user and provided by a telecommunications network, such as a network that provides communication services to the user, with a credit associated with the external online event. The database may store or track credits or other currency or tokens associated with redeeming awards provided via the network by various sponsoring entities, companies, or brands.

When the user attempts to redeem a reward (either immediately after the event, or at a later time), the systems and methods access the database to confirm the user has available currency or credits to redeem the reward. Further, the systems and methods access and utilize information provided by other network-based components to verify the user, determine the validity of the user's request for a reward, determine an availability of a reward, and so on. Thus, in some cases, the systems and methods, via a database stored by a network carrier billing system, manage the redemption of rewards provided to users at external online environments (e.g., sponsor or brand web sites, mobile applications, and so on).

The systems and methods, therefore, leverage various network billing systems to immediately and efficiently provide users with credits after they participate in marketing and other online events, enabling the users to quickly redeem rewards provided to the users during the events, among other benefits.

As an example, a wireless network carrier puts on a weekly or periodic promotional event, where the carrier partners with various companies or brands to provide subsidized or free products or services. The carrier promotes the sponsor by advertising the product or service, which is then either given away or sold at a discount during a promotional event (either online or within an associated retail store or location). Via specific brands and companies, the carrier associates itself with brands that meet a desired profile (e.g., a youth market), and at the same time, develops a social network with its customers, who benefit from the promotions and increase their activity in both online and retail environments.

As discussed herein, unfortunately, in practice, due to confirming links to online rewards or promotions, detecting fraud, inefficient inventory control, redirected priorities, and other hindrances, partner sponsors may send or transfer rewards (e.g., gift cards) as much as six to eight weeks after an online marketing event. The systems and methods, therefore, perform the various processes described herein to overcome such hindrances, by leveraging the robust back end infrastructure of the wireless network carrier to authorize participating users and track their reward activities and actions.

In some embodiments, the systems and methods provision a product or service to a user associated with a telecommunications network provided by a network carrier. First, the systems and methods receive, at an enterprise server internal to the telecommunications network and associated with the network carrier, information associated with an occurrence of a reward activity event performed by the user at a remote web browser or mobile application. Then, the systems and methods determine a current eligibility of a reward associated with provisioning the product or service to the user based on a rules-based process performed by a rules engine of the internal enterprise server.

When the reward associated with provisioning the product or service to the user is currently available for redemption based on the rules-based process performed by the rules engine, the systems and methods update a reward specific database with a credit for the user. Finally, the systems and methods cause the remote web browser or mobile application to present information that identifies the product or service that has been provisioned to the user. The user may then immediately and efficiently redeem the product or service via the web site.

In the following description, for the purposes of explanation, numerous specific details are set forth in order to provide a thorough understanding of embodiments of the present technology. It will be apparent, however, that embodiments of the present technology may be practiced without some of these specific details.

### Examples of Suitable Network Environments

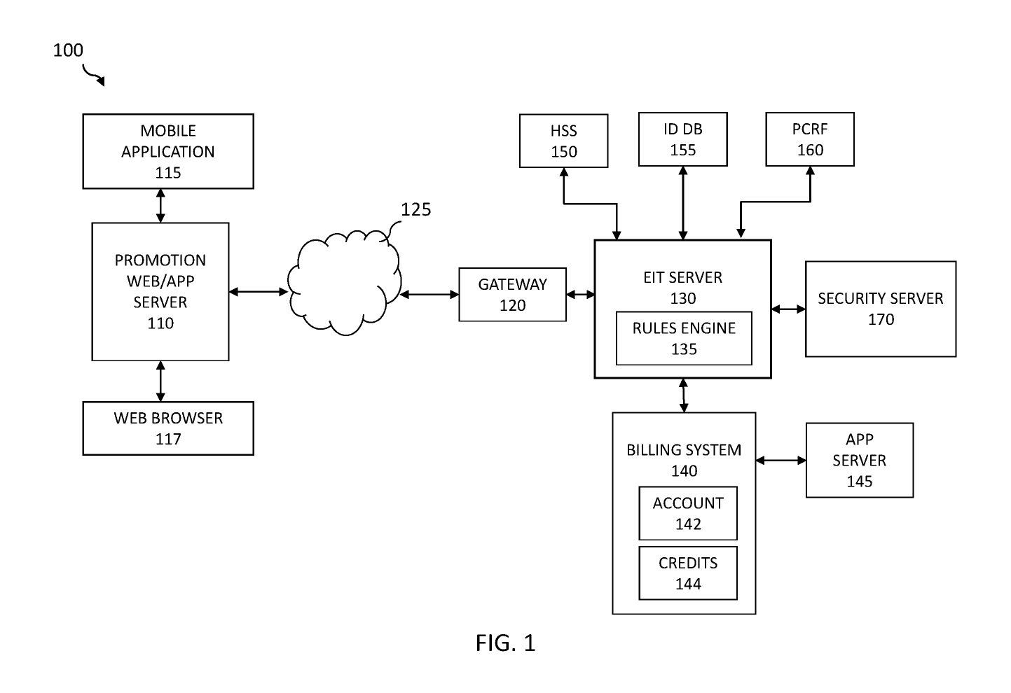

As described herein, in some embodiments, the systems and methods utilize telecommunications network-based servers, components, engines, and/or processes to provision rewards to users originating from external online events and associated with partner companies, sponsors, and/or brands. FIG. 1 is a block diagram illustrating a suitable computing environment 100 for provisioning rewards to users of a telecommunications network.

A promotion web server or application server 110 performs, or causes to be performed, a marketing event, such as an online event, at one or more devices associated with a user. A mobile application 115 or web browser 117 provided by a mobile device, such as a smart phone, tablet, or laptop and/or operating system applications or launchers perform the marketing events. For example, the user may be a customer of a network carrier that provides a communications network 125 via which the mobile application 115 and/or web browser 117 receive and send data and other communications. The customer may visit a web page via the mobile application 115, web browser 117, or OS based applications, and perform an action or activity presented via the web page, such as click a button, play a game, answer a question, provide feedback, simply visit the page, watch a video or other content, register for a service, share or blog about a topic, and so on.

Once the customer (of the network carrier providing network 125) performs the action or activity, the customer triggers a reward event or action associated with the marketing event at the web page. A reward event is triggered by any completion or commencement of an activity or action requested of the customer. As described herein, a reward event includes providing the customer with a reward, award, incentive, or other benefit for being a customer and/or participating (e.g., actively or inactively) via the mobile application 115 or web browser 117.

The server 110, in response to the triggering of the reward event, transmits, via a backend interface, information associated with the customer, reward event, and/or marketing event to an internal enterprise (EIT) server 130 over the network 125. As described herein, the network 125 may be provided by the network carrier, and may include a cellular or other telecommunications network, the Internet, and/or another network.

Communications received from the backend interface of the server 110 are initially managed by a network gateway 120, which performs various authentication processes (e.g., via the OAuth 2.0 protocol), and routes communications to the internal server 130 (or, to one of multiple EIT servers) of the network carrier.

The internal EIT server 130 includes a rules engine 135, which performs logic-based qualification determinations for potential reward redemptions. For example, the rules engine 135 may apply various restrictions or parameters to reward events presented by the promotion server 110. Example restrictions include inventory or amount restrictions, customer restrictions, group or family restrictions, location restrictions, time restrictions, and so on.

When applying reward redemption rules, the rules engine 135 accesses and/or retrieves information from various network specific components. In some cases, the rules engine 135 receives customer identity information from a Home Subscriber Server (HSS) 150 (or Home Location Register, or HLR), which provides subscription-related information such as subscriber profiles, performs authentication/authorization processes for users, provides information associated with a subscriber's location and/or IP information, and so on.

In addition, the rules engine 135 may receive information from an internal ID database 155, such as a database managed by the network carrier. The ID database 155 provides user equipment information (e.g., International Mobile Subscriber Identity (IMSI) information or Mobile Station International Subscriber Directory Number (MSISDN) information), billing account number (BAN) information, primary account holder (PAH) information, and so on, for a customer or group of customers (e.g., family).

Further, the rules engine 135 accesses or receives information from a Policy and Charging Rules Function (PCRF) node or component 160. The PCRF 160 operates with the core of the network 125, accesses subscriber databases (e.g., ID DB 155) and other network functions, such as a charging system (not shown) configured to access, identify, and/or apply a current billing policy associated with the subscriber. Further details regarding the processes performed by the rules engine 135 are described herein.

In some embodiments, the internal EIT server 130, via the rules engine 135, accesses a security server 170 of the network 125. The security server 170 may include components configured to monitor and detect fraudulent activity within the network 125. For example, the security server 170 may run processes configured to identify patterns (e.g., fraudulent or suspicious) of activity associated with a certain user identifier (e.g. IMSI) or device, such as multiple accesses or redemption requests. The rules engine 135 may query the security server 170 to authenticate a customer, device, and/or reward redemption request by checking, against data stored by the server 170, the timing of a request, the IP address of the request, the account associated with the request, the login credentials provided along with a request, and so on.

The internal EIT server 130, in some embodiments, accesses and/or utilizes a billing system 140 of the network carrier to track, manage, or otherwise provide a customer or user with a credit or other currency upon redeeming a reward. For example, the billing system 140 may include, for some or all customers of the network provider, a reward redemption database 144 (e.g., storing credits) along with an account database 142, which is associated with regular customer activities (e.g., data, text, and/or voice services) within the network 125. The billing system 140 may interface with an application server 145, internal to the network carrier, which facilitates communications between a network carrier provided mobile application (e.g., mobile application 115) and the billing system 140.

FIG. 1 and the discussion herein provide a brief, general description of a suitable computing environment in which the EIT server 130 and associated rules engine 135 can be supported and implemented. Although not required, aspects of the system or server 130 are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” are generally used interchangeably herein, as are “mobile device” and “handset,” and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

In some embodiments, the devices may include network communication components that enable the devices to communicate with remote servers or other portable electronic devices by transmitting and receiving wireless signals using a licensed, semi-licensed, or unlicensed spectrum over communications network, such as network 125. In some cases, the telecommunication network 125 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The communications network 125 may also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5G mobile communications network, IEEE 802.11 (WiFi), or other communications network. Thus, the user device is configured to operate and switch among multiple frequency bands for receiving and/or transmitting data.

### Examples of Provisioning Rewards to Users of a Telecommunications Network

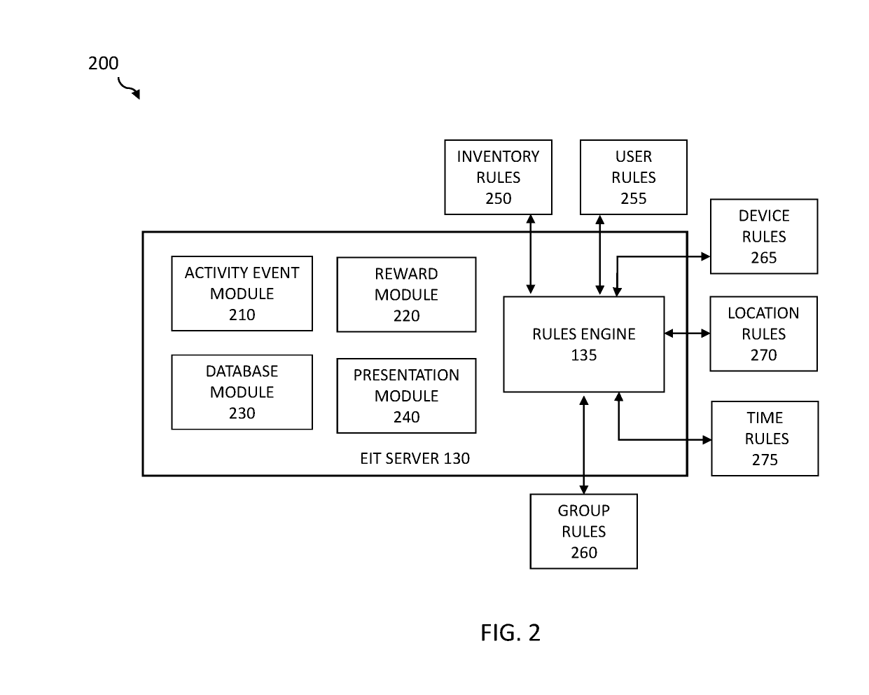

As described herein, in some embodiments, the systems and methods provision credits and other currency to users who complete or otherwise satisfy reward events via one or more systems (e.g., a billing system) of a communications network, such as a cellular network provided by a network carrier. FIG. 2 is a block diagram illustrating various modules of the internal enterprise (EIT) server 130.

The EIT server 135 includes functional modules or engines that are implemented with a combination of software (e.g., executable instructions, or computer code) and hardware (e.g., at least a memory and processor). Accordingly, as used herein, in some examples a module or engine is a processor-implemented module or set of code and represents a computing device having a processor that is at least temporarily configured and/or programmed by executable instructions stored in memory to perform one or more of the particular functions that are described herein. For example, the EIT server 130 may include an activity event module 210, a reward module 220, a database module 230, and a presentation module 240.

In some embodiments, the activity event module 210 is configured and/or programmed to receive information associated with an occurrence of a reward activity event performed by the user at a remote web browser or mobile application. For example, the activity event module 210 may receive from the mobile application 115 or web browser 117 information associated with a user performing or commencing a marketing event or other online event, such as via a web page associated with a partner sponsor or brand.

In some cases, the user is a customer of the network carrier and logs on with a customer identifier (e.g., MSISDN, phone number, username for the network carrier, email address, and so on) to the web site, which presents a promotion or other branded activity or event. When the web site is provided by the sponsor, the web site may link or otherwise associate authentication via a network carrier specific identifier, such as a username specific to authorizing the user to use services or systems provided by the network carrier. In such cases, the username may be associated with multiple individuals (e.g., family members within a family, group, or shared plan), and/or multiple devices.

As described herein, the user (or customer) may perform various actions or activities while viewing or interacting with the web site, such as activities that trigger a reward event on the web site. For example, clicking on a button or performing a task or other action triggers execution of a routine on the promotion server 110, such as a routine that identifies the user, the reward event, and other contextual information, and transfers the information to the EIT server 130.

Example information transferred to the EIT server 130 includes information associated with a user, information associated with a group of users, user equipment information (e.g., device type, make, model, operating system, and so on), geo-location or other location information, date and/or time information (e.g., a timestamp), context information associated with a user's online activities, information about a user's communication medium (e.g., which channel), and so on. The activity event module 210 receives or otherwise accesses the information.

In some embodiments, the reward module 220 is configured and/or programmed to determine a current eligibility of a reward associated with provisioning the product or service to the user based on a rules-based process. For example, the reward module 220 interfaces with the rules engine 135 to determine whether a user is eligible for a reward promoted by the web site.

The rules engine 135 applies various rules to a current promotion, to determine a user's eligibility at time of redemption. Such rules may be stored by the rules engine 135 and/or provided from external databases, such as databases associated with the partner sponsor or brand and/or the network carrier. As depicted in FIG. 2, the rules engine 135 may access and apply some or all of the following rules when determining user eligibility of a promotion presented by an online event:
Inventory restriction rules 250, such as rules that identify or constrain a promotion to a certain number of award or reward redemptions (e.g., only the first N redemptions qualify);
Individual or user restriction rules 255, such as rules that limit access to a promotion by any user, customer, or individual (e.g., only one redemption per customer);
Group restriction rules 260, such as rules that limit access to a promotion by any group of individuals (e.g., only one redemption per family or group of users that share a single network identifier);
User Equipment restriction rules 265, such as rules that limit access to a promotion from a certain device (e.g., only redeemable if user has a certain device make/model and/or device type, such as a tablet);
Location restriction rules 270, such as rules that limit access to a promotion to a certain location (e.g., only redeemable within the United States);
Time restriction rules 275, such as rules that limit access to a promotion within a certain time period (e.g., only redeemable within January 2019); and so on.

Of course, the rules engine 135 may apply single rules and/or any combination of rules when determining eligibility. For example, a promotion for 25 percent off at a web site selling baseball merchandise may restrict eligibility to users on smart phones within the United States that redeem the promotion during the baseball season.

In some cases, the reward module 220 may perform other screening or filtering of users when determining eligibility. For example, the reward module 220 may access the billing system 140, and determine whether a user is current with network account. As another example, the reward module 220 may determine whether the user has continued with a prepaid account.

The rules engine 135, in applying the various restriction rules, utilizes information received from the online event (from server 110) as well as from other information sources, such as sources associated with providing the network 125 to users. For example, the rules engine 135, as described herein, accesses, receives, or retrieves information from a variety of different network-based data sources or components and/or from partner companies or brands.

In some cases, the rules engine 135 retrieves from the Home Subscriber Server (HSS) 150, or Home Location Register (HLR), subscriber information for the user. Further, the rules engine 135 retrieves, from the internal ID database 155 managed by the network carrier, International Mobile Subscriber Identity (IMSI) information or Mobile Station International Subscriber Directory Number (MSISDN) information, and billing account number (BAN) information for the user,

Also, the rules engine 135 retrieves, from the Policy and Charging Rules Function (PCRF) node 160 of the telecommunications network, a current billing policy and/or charging policy associated with the user and/or applied within the network. For example, the PCRF 160 may collect and rate, in real time, data and other transactions within the network 125, and perform actions based on such collection or management of charging policies and functions. The rules engine 135, utilizing information of a current or dynamic charging policy, may, in real time, adjust the eligibility of any promotion, based on a current status of the charging policy within the network 125.

Using some or all of the retrieved information, the rules engine 135 compares the retrieved subscriber information, the retrieved IMSI or MSISDN information, the BAN information, and/or the current billing policy (or, charging policy) to determine whether the product or service is eligible to be provisioned to the user.

In some embodiments, the database module 230 is configured and/or programmed to update a reward-specific database with a credit for the user when the reward associated with provisioning the product or service to the user is currently available for redemption based on the rules-based process. For example, the database module 230 may update a separate promotion- or reward-specific database within the billing system 140 with a credit, token, point (or points) or other online currency or tracking data, in response to the user performing the activity at the promotion web site.

Thus, if a customer is qualified, the database module 230 adds or increments a credit or points in the billing system 140 on behalf of the customer. The credits may, in some cases, be related or associated with the promotion and/or may be temporarily provided to users and expire after a certain period of time. For example, credits may be limited in what they can be redeemed for, such as limited to a specific product or service, limited to a specific brand or sponsor, limited to a certain redemption time period, limited in whether they are combined with other promotions, and so on. Of course, credits may be stored for individuals or groups of individuals (e.g., a family).

In some embodiments, the presentation module 240 is configured and/or programmed to cause the remote web browser 117 or mobile application 115 to present information that identifies the product or service has been provisioned to the user. For example, the presentation module 240 may expose an Application Programming Interface (API) to the remote web browser 117 or mobile application 115, which facilitates access by the remote web browser 117 or mobile application 115 to the internal enterprise server 130.

Via the API or via other communication channels, the presentation module 240 may facilitate access to various information associated with a user's reward redemptions, including a total number of points awarded, a total number of points redeemed, the user's redemption history (e.g., identities of products/services, redemption times, and so on), a time at which points are to expire, current eligible rewards to be provisioned to the user, and so on.

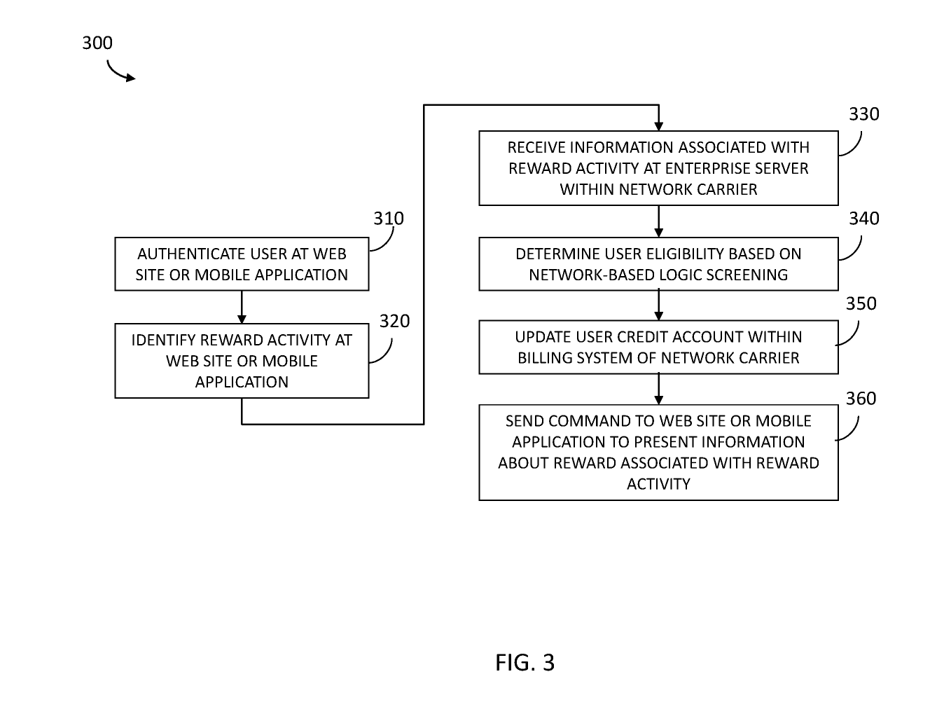

Thus, as described herein, the EIT server 130 performs various functions and/or processes to facilitate the redemption of rewards provided to users at external web sites or pages, such as partner or sponsor web pages. FIG. 3 is a flow diagram illustrating a method 300 for providing a reward to a user of a telecommunications network. The method 300 may be performed by the EIT server 130 and, accordingly, is described herein merely by way of reference thereto. It will be appreciated that the method 300 may be performed on any suitable hardware.

First, in operation 310, a web site, such as a site provided via the mobile application 115 or web browser 117, authenticates a user. As described herein, the user may provide various log in credentials, such as a phone number or network carrier identifier (e.g., username) in order to facilitate the authentication.

In operation 320, the application server 110 determines or identifies an occurrence of a reward activity or action at the web site. For example, the application server 110 may be triggered when the user performs an action or activity presented via the web site, such as clicks a button, plays a game, answers a question, provides feedback, visits the page, watches a video or other content, registers for a service, shares or blogs about a topic, and so on.

In operation 330, the EIT server 130 receives information associated with the occurrence of the reward activity event performed by the user at the remote web browser or mobile application. For example, the activity event module 210 may receive from the mobile application 115 or web browser 117 information associated with a user performing or commencing a marketing event or other online event, such as via a web page associated with a partner sponsor or brand.

In operation 340, the EIT server 130 determines a current eligibility of a reward associated with provisioning the product or service to the user based on a rules-based process performed by a rules engine of the internal enterprise server. For example, the reward module 220 interfaces with the rules engine 135 to determine whether a user is eligible for a reward promoted by the web site. The rules engine 135 applies various rules to a current promotion to determine a user's eligibility at time of redemption. Such rules may be stored by the rules engine 135 and/or provided from external databases, such as databases associated with the partner sponsor or brand and/or the network carrier.

In operation 350, the EIT server 130 updates a reward-specific database with a credit for the user when the reward associated with provisioning the product or service to the user is currently available for redemption based on the rules-based process performed by the rules engine 135. For example, the database module 230 may update a separate, promotion- or reward-specific database within the billing system 140 with a credit, token, point (or points) or other online currency or tracking data in response to the user performing the activity at the promotion web site.

In operation 360, the EIT server 130 sends a command to the remote web browser or mobile application requesting that the web browser or mobile application present information to the user that identifies the product or service that has been provisioned to the user, thus causing the remote web browser or mobile application to present the information. For example, the presentation module 240 may expose an Application Programming Interface (API) to the remote web browser 117 or mobile application 115, which facilitates access by the remote web browser 117 or mobile application 115 to the internal enterprise server 130.

As described herein, in some cases, the EIT server 130, via the rules engine 135, may query the security server 170 to authenticate a customer, device, and/or reward redemption request by checking, against data stored by the server 170, the timing of a request, the IP address of the request, the account associated with the request, the login credentials provided along with a request, and so on.

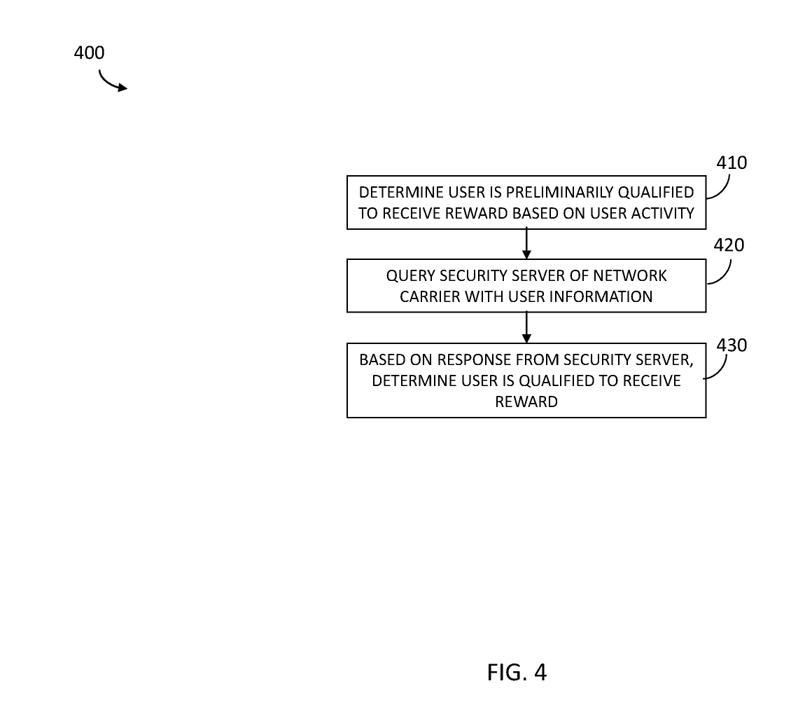

FIG. 4 is a flow diagram illustrating a method 400 for determining the authenticity of a user reward recipient device. The method 400 may be performed by the EIT server 130 and, accordingly, is described herein merely by way of reference thereto. It will be appreciated that the method 400 may be performed on any suitable hardware.

In operation 410, the EIT server 130 determines the user is preliminarily eligible to receive the product or service. For example, the EIT server 130 may receive an indication from the rules engine 135 that the promotion is eligible for redemption by the user.

In operation 420, the EIT server 130 queries a security server associated with the network carrier with information associated with the user or the occurrence of the reward activity event performed by the user. For example, the EIT server 130 queries the security server 170, which performs a comparison of the information associated with the user or the occurrence of the reward activity event performed by the user with information associated with fraudulent activity performed within the telecommunications network and tracked by the security server.

In operation 430, the EIT server 130, based on results of the query received from the security server, determines the user is eligible to receive the product or service. For example, after the security server 170 determines the user, or his/her device, is not associated with any fraudulent activity or patterns of unscrupulous activity with the network 125, the EIT server completes the determination of qualifying the user to redeem the reward (e.g., receive the product or service).

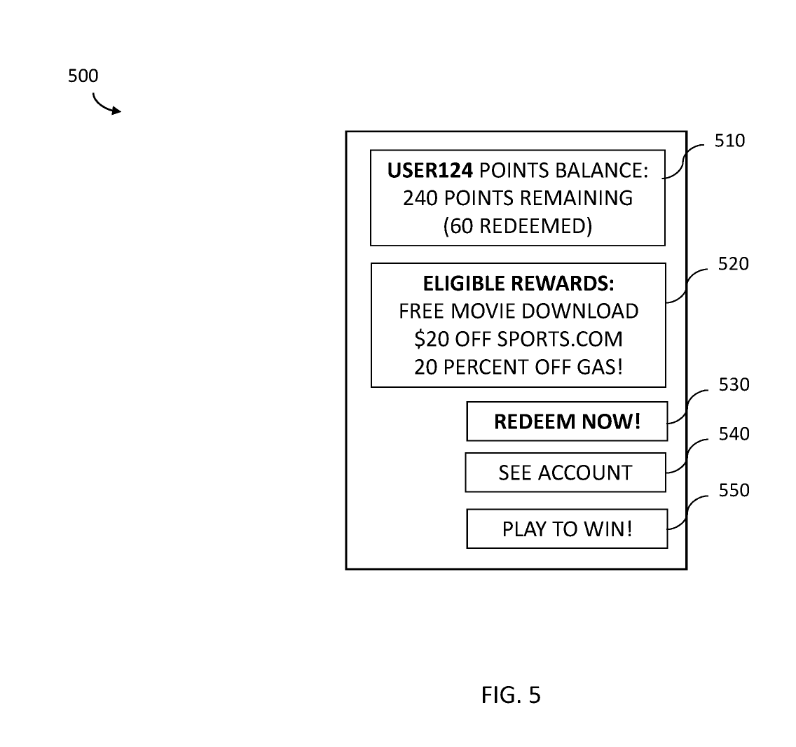

As described herein, in some embodiments, the web browser 117 or mobile application 115 (or, any other web site or application associated with the network carrier) presents various information associated with a user's eligible rewards, reward redemption activity, points or credits balances, and so on. FIG. 5 is a display diagram illustrating an example user interface 500 for presenting information associated with a user's reward activity.

As depicted, the user interface 500 displays a remaining points balance 510 for a user (e.g., “user 124”), as well as redemption history information. The user interface also presents various promotions eligible for redemption by the user, such as a “free movie download” from a sponsoring streaming site, a rebate from a retail site (“sports.com”), a discount for gas from a sponsoring gas station, and others.

The user interface 500 presents other user-selectable options, such as an option 530 to redeem other rewards via the user's points balance, an option 540 to see additional account details, an option 550 to play a raffle, lottery or other award games, and so on.

Thus, in some embodiments, the EIT server 130 causes the rendering of the user interface 500 with the depicted information to facilitate the immediate and timely redemption of rewards associated with partner companies and brands, without delays typical of such promotions.

As described herein, a network carrier utilizes an internal enterprise server to manage and control the provisioning of rewards to its customers at various external web environments, such as partner web sites. The enterprise server determines the eligibility of rewards using information collected and stored by various components of a telecommunications network and associated with the network carrier. Thus, the network carrier, via the enterprise server, enables a valid and secure provision of rewards to users by relying on network-based components and provides such rewards immediately after their initial availability to the users, among other benefits.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A system associated with a Policy and Charging Rules Function (PCRF) node of a wireless telecommunications network provided by a wireless network carrier, the system comprising:
at least one hardware processor coupled to a billing or charging server in the wireless telecommunications network;
at least one hardware memory and coupled to the at least one processor, wherein the at least one memory stores software modules, wherein the at least one hardware processor is configured to execute the software modules, and wherein the software modules include:
an activity event module that receives information associated with an occurrence of a reward activity event performed by a user at a remote web browser or mobile application,
wherein the user is a subscriber to the wireless telecommunications network;
a reward module that determines a current eligibility of a reward associated with provisioning the product or service to the user based on a rules-based process;
a database module that updates a reward-specific database with a credit for the user when the reward associated with provisioning the product or service to the user is currently available for redemption based on the rules-based process,
wherein the database module is in communication with the billing or charging server; and
a presentation module that causes the remote web browser or mobile application to present information that identifies the product or service that has been provisioned to the user.

2. The system of claim 1, wherein the reward module:
retrieves, from a Home Subscriber Server (HSS) or Home Location Register (HLR), subscriber information for the user;
retrieves, from an internal ID database managed by the network carrier, user information for the user;
retrieves, from the Policy and Charging Rules Function (PCRF) node of the telecommunications network, a current billing policy associated with the user; and
compares the retrieved subscriber information, the retrieved user information, and the current billing policy to determine whether the product or service is eligible to be provisioned to the user.

3. A network-based method of provisioning a product or service to a user who subcribes to wireless services with a wireless telecommunications network provided by a network carrier, the method comprising:
receiving, at an enterprise server internal to the telecommunications network and associated with the network carrier, information associated with an occurrence of a reward activity event performed by the user at a remote web browser or mobile application;
determining a current eligibility of a reward associated with provisioning the product or service to the user based on a rules-based process performed by a rules engine of the internal enterprise server;
when the reward associated with provisioning the product or service to the user is currently available for redemption based on the rules-based process performed by the rules engine, updating a reward-specific database with a credit for the user,
wherein the reward-specific database is associated with the user and is stored by a billing system internally managed by the network carrier and accessible by the internal enterprise server; and
sending, by the enterprise server, a command to the remote web browser or mobile application requesting that the web browser or mobile application present information to the user that identifies the product or service that has been provisioned to the user.

4. The method of claim 3, wherein determining a current eligibility of a reward associated with provisioning the product or service to the user based on a rules-based process performed by a rules engine of the internal enterprise server includes:
retrieving, from a Home Subscriber Server (HSS) or Home Location Register (HLR), subscriber information for the user;
retrieving, from an internal ID database managed by the network carrier, International Mobile Subscriber Identity (IMSI) information or Mobile Station International Subscriber Directory Number (MSISDN) information, and billing account number (BAN) information for the user;
retrieving, from a Policy and Charging Rules Function (PCRF) node of the telecommunications network, a current billing policy associated with the user; and
comparing the retrieved subscriber information, the retrieved IMSI or MSISDN information, the BAN information, and the current billing policy to determine whether the product or service is eligible to be provisioned to the user.

5. The method of claim 3, wherein the occurrence of a reward activity event performed by the user at a remote web browser or mobile application includes performance of an activity or action associated with a branded product or server by the user at the remote web browser or mobile application.

6. The method of claim 3, wherein sending the command to the remote web browser or mobile application to present information includes exposing an Application Programming Interface (API) to the remote web browser or mobile application, which facilitates access by the remote web browser or mobile application to the internal enterprise server.

7. The method of claim 3, wherein determining a current eligibility of a reward associated with provisioning the product or service to the user based on a rules-based process performed by a rules engine of the internal enterprise server includes:
determining the user is preliminarily eligible to receive the product or service;
querying a security server associated with the network carrier with information associated with the user or the occurrence of the reward activity event performed by the user,
wherein the security server performs a comparison of the information associated with the user or the occurrence of the reward activity event performed by the user with information associated with fraudulent activity performed within the telecommunications network and tracked by the security server; and
based on results of the query received from the security server, determining the user is eligible to receive the product or service.

8. The method of claim 3, wherein updating a reward specific database with a credit for the user includes updating the reward specific database with one or more credits that are valid for a certain period of time.

9. The method of claim 3, wherein updating a reward specific database with a credit for the user includes updating the reward specific database with one or more credits that are specific to the product or service provisioned to the user.

10. The method of claim 3, wherein updating a reward specific database with a credit for the user includes updating the reward specific database with one or more credits that are specific to a sponsor or brand that provided the product or service.

11. The method of claim 3, wherein receiving information associated with an occurrence of a reward activity event performed by the user at a remote web browser or mobile application includes receiving information from a web page associated with a sponsor or brand of the product or service and presented by the remote web browser.

12. The method of claim 3, wherein receiving information associated with an occurrence of a reward activity event performed by the user at a remote web browser or mobile application includes receiving information from a mobile application associated with the network carrier.

13. A non-transitory computer-readable medium whose contents, when executed by an internal server of a telecommunications network provided by a network carrier, cause the internal server to perform operations for provisioning a product or service to a user associated with the telecommunications network, the operations comprising:
receiving, at an enterprise server internal to the telecommunications network and associated with the network carrier, information associated with an occurrence of a reward activity event performed by the user at a remote web browser or mobile application;
determining a current eligibility of a reward associated with provisioning the product or service to the user based on a rules-based process performed by a rules engine of the internal enterprise server;
when the reward associated with provisioning the product or service to the user is currently available for redemption based on the rules-based process performed by the rules engine, updating a reward specific database with a credit for the user,
wherein the reward specific database associated with the user and stored by a billing system internally managed by the network carrier and accessible by the internal enterprise server; and
sending, by the enterprise server, a command to the remote web browser or mobile application requesting that the web browser or mobile application present information to the user that identifies the product or service that has been provisioned to the user.

14. The non-transitory computer-readable medium of claim 13, wherein determining a current eligibility of a reward associated with provisioning the product or service to the user based on a rules-based process performed by a rules engine of the internal enterprise server includes:
retrieving, from a Home Subscriber Server (HSS) or Home Location Register (HLR), subscriber information for the user;
retrieving, from an internal ID database managed by the network carrier, International Mobile Subscriber Identity (IMSI) information or Mobile Station International Subscriber Directory Number (MSISDN) information, and billing account number (BAN) information for the user;
retrieving, from a Policy and Charging Rules Function (PCRF) node of the telecommunications network, a current billing policy associated with the user; and
comparing the retrieved subscriber information, the retrieved IMSI or MSISDN information, the BAN information, and the current billing policy to determine whether the product or service is eligible to be provisioned to the user.

15. The non-transitory computer-readable medium of claim 13, wherein the occurrence of a reward activity event performed by the user at a remote web browser or mobile application includes performance of an activity or action associated with a branded product or server by the user at the remote web browser or mobile application.

16. The non-transitory computer-readable medium of claim 13, wherein sending the command to the remote web browser or mobile application to present information includes exposing an Application Programming Interface (API) to the remote web browser or mobile application, which facilitates access by the remote web browser or mobile application to the internal enterprise server.

17. The non-transitory computer-readable medium of claim 13, wherein determining a current eligibility of a reward associated with provisioning the product or service to the user based on a rules-based process performed by a rules engine of the internal enterprise server includes:
determining the user is preliminarily eligible to receive the product or service;
querying a security server associated with the network carrier with information associated with the user or the occurrence of the reward activity event performed by the user,
wherein the security server performs a comparison of the information associated with the user or the occurrence of the reward activity event performed by the user with information associated with fraudulent activity performed within the telecommunications network and tracked by the security server; and
based on results of the query received from the security server, determining the user is eligible to receive the product or service.

18. The non-transitory computer-readable medium of claim 13, wherein updating a reward specific database with a credit for the user includes updating the reward specific database with one or more credits that are valid for a certain period of time.

19. The non-transitory computer-readable medium of claim 13, wherein updating a reward specific database with a credit for the user includes updating the reward specific database with one or more credits that are specific to the product or service provisioned to the user.

20. The non-transitory computer-readable medium of claim 13, wherein updating a reward specific database with a credit for the user includes updating the reward specific database with one or more credits that are specific to a sponsor or brand that provided the product or service.
